(19) United States
(12) Patent Application Publication
(10) Pub. No.: US 2025/0142345 A1
(43) Pub. Date: May 1, 2025

(54) Handover Interface Signaling in Lawful Interception

(71) Applicant: Telefonaktiebolaget LM Ericsson (publ), Stockholm (SE)

(72) Inventors: Tiziana Bellavista, Gaeta (LT) (IT); Mario Ascione, Torre del Greco (NA) (IT); Domenico Raffaele Cione, Caserta (IT)

(21) Appl. No.: 18/835,396

(22) PCT Filed: Feb. 3, 2022
(86) PCT No.: PCT/EP2022/052645

§ 371 Date: Aug. 2, 2024

(51) Int. Cl. H04W 12/80; H04W 36/00; H04W 80/10

(52) U.S. Cl. CPC H04W 12/80; H04W 36/0011; H04W 80/10

(57) ABSTRACT

A network mediation device (32) in a communication network (10) receives application-layer control messages (24) intercepted in the communication network (10) as part of a lawful interception service. Each of the application-layer control messages (24) received is configurable to include (i) a session identity field (28) indicating an identity of an application-layer control session (26) to which the application-layer control message belongs: and (ii) one or more linking fields (30) that link the identified application-layer control session (26) with another application-layer control session (26). The network mediation device (32) sends. over a handover interface (33) from the network mediation device (32) towards a law enforcement device (16), the application-layer control messages (24) and signaling (34) indicating which application-layer control messages (24) belong to application-layer control sessions (26) that are linked to one another.

### TECHNICAL FIELD

The application relates generally to lawful interception in a communication network, and relates more specifically to handover interface signaling for such lawful interception.

### BACKGROUND

Lawful Interception (LI) allows law enforcement agencies (LEAs) to obtain data from a communication network pursuant to lawful authority, e.g., a warrant, for the purpose of analysis or evidence. See, e.g., 3GPP Technical Specification (TS) 33.127 v17.1.0 for LI as specified by 3GPP. According to LI, a point of interception (POI) in the communication network intercepts data and transfers the intercepted data to a network mediation device that is the mediator between the communication network and a law enforcement device. After conditioning the intercepted data for transport, the network mediation device sends the data over a handover interface to the law enforcement device.

As part of preparing the intercepted data for transport over the handover interface, the network mediation device labels the intercepted data with a Communication Identifier (CID) field to uniquely identify a communication session to which the intercepted data belongs. This way, the law enforcement device's analysis can discriminate intercepted data based on the communication session to which the data belongs.

Challenges exist, though, in that the definition of the communication session identified by the CID field is service-specific. For some types of services, then, such as for an asynchronous communication service, the CID field may fail to identify a communication session at the level of granularity desired by a law enforcement agency. In this case, the law enforcement agency must perform additional processing of the intercepted data in an attempt to discriminate intercepted data based on communication sessions which are defined at the desired level of granularity. This additional processing proves complex, inefficient, and costly.

### SUMMARY

An object is to enable a reduction in the processing complexity, inefficiency, and/or cost imposed on a law enforcement agency as part of lawful interception (LI).

Some embodiments herein enhance a handover interface for lawful interception in a communication network with signaling that indicates which intercepted application-layer control messages belong to application-layer control sessions that are linked to one another. Such signaling may for instance enable a law enforcement agency to discriminate the intercepted application-layer control messages based on sessions which are defined at a coarser level of granularity, e.g., based on groups of application-layer control sessions that are linked rather than based on individual application-layer control sessions. With the signaling indicating this directly, the law enforcement agency need not perform additional processing to deduce which application-layer control messages belong to application-layer control sessions that are linked to one another. Some embodiments thereby advantageously reduce the complexity, inefficiency, and/or cost of analyzing the intercepted data at the law enforcement agency.

More particularly, embodiments herein include a method performed by a network mediation device in a communication network. The method comprises receiving application-layer control messages intercepted in the communication network as part of a lawful interception service. In some embodiments, each of the application-layer control messages received is configurable to include a session identity field indicating an identity of an application-layer control session to which the application-layer control message belongs. In some embodiments, each of the application-layer control messages received is configurable to include one or more linking fields that link the identified application-layer control session with another application-layer control session. The method further comprises sending, over a handover interface from the network mediation device towards a law enforcement device, the application-layer control messages and signaling indicating which application-layer control messages belong to application-layer control sessions that are linked to one another.

In some embodiments, the method further comprises labeling each application-layer control message with a field. In some embodiments, the signaling comprises the value of the field across the application-layer control messages as labeled. In one embodiment, sending the application-layer control messages and the signaling comprises sending the application-layer control messages as labeled with the field. In one or more of these embodiments, the method further comprises setting the field to have the same value across application-layer control messages which belong to application-layer control sessions that are linked to one another and to have different values across application-layer control messages which belong to application-layer control sessions that are not linked to one another. In some embodiments, the field is an extended session field which is different than a Communications Identity Number field in each application-layer control message. In other embodiments, the field is a Communications Identity Number field whose value identifies a communications session.

In some embodiments, the method further comprises determining which application-layer control messages belong to application-layer control sessions that are linked to one another, based on the session identity field and the one or more linking fields of each application-layer control message.

In some embodiments, the application-layer control messages are Session Initiation Protocol, SIP, messages. In one or more of these embodiments, an application-layer control session corresponds to a SIP call leg. In some embodiments, the session identity field is a Call-ID field, and the one or more linking fields include an In-Reply-To field.

In some embodiments, for an application-layer control message that is a response to a previous application-layer control message, the one or more linking fields included in the application-layer control message indicate an identity of an application-layer control session to which the previous application-layer control message belongs.

In some embodiments, the application-layer control messages are messages of an asynchronous communication service.

In some embodiments, the application-layer control messages are messages of a Short Messaging Service, SMS.

Other embodiments herein include a method performed by a law enforcement device. The method comprises receiving, over a handover interface from a network mediation device in a communication network, application-layer control messages intercepted in the communication network as part of a lawful interception service. In some embodiments, each of the application-layer control messages received is configurable to include a session identity field indicating an identity of an application-layer control session to which the application-layer control message belongs. In some embodiments, each of the application-layer control messages received is configurable to include one or more linking fields that link the identified application-layer control session with another application-layer control session. The method also comprises receiving, over the handover interface, signaling indicating which application-layer control messages belong to application-layer control sessions that are linked to one another.

In some embodiments, each application-layer control message is labeled with a field. In some embodiments, the signaling comprises the value of the field across the application-layer control messages as labeled, and receiving the application-layer control messages and the signaling comprises receiving the application-layer control messages as labeled with the field. In one or more of these embodiments, the field has the same value across application-layer control messages which belong to application-layer control sessions that are linked to one another and has different values across application-layer control messages which belong to application-layer control sessions that are not linked to one another. In one or more of these embodiments, the field is an extended session field which is different than a Communications Identity Number field in each application-layer control message. In one or more of these embodiments, the field is a Communications Identity Number field whose value identifies a communications session.

In some embodiments, the application-layer control messages are Session Initiation Protocol, SIP, messages. In one or more of these embodiments, an application-layer control session corresponds to a SIP call leg. In some embodiments, the session identity field is a Call-ID field, and the one or more linking fields includes an In-Reply-To field.

In some embodiments, for an application-layer control message that is a response to a previous application-layer control message, the one or more linking fields included in the application-layer control message indicate an identity of an application-layer control session to which the previous application-layer control message belongs.

In some embodiments, the application-layer control messages are messages of an asynchronous communication service.

In some embodiments, the application-layer control messages are messages of a Short Messaging Service, SMS.

In some embodiments, the method further comprises processing the received application-layer control messages based on which application-layer control messages belong to application-layer control sessions that are linked to one another according to the signaling.

Other embodiments herein include a network mediation device in a communication network. The network mediation device is configured to receive, at the network mediation device, application-layer control messages intercepted in the communication network as part of a lawful interception service. In some embodiments, each of the application-layer control messages received is configurable to include a session identity field indicating an identity of an application-layer control session to which the application-layer control message belongs. In some embodiments, each of the application-layer control messages received is configurable to include one or more linking fields that link the identified application-layer control session with another application-layer control session. The network mediation device is also configured to send, over a handover interface from the network mediation device towards a law enforcement device, the application-layer control messages and signaling indicating which application-layer control messages belong to application-layer control sessions that are linked to one another

In some embodiments, the network mediation device is configured to perform the steps described above for a network mediation device.

Other embodiments herein include a law enforcement device configured to receive, over a handover interface from a network mediation device in a communication network, application-layer control messages intercepted in the communication network as part of a lawful interception service. In some embodiments, each of the application-layer control messages received is configurable to include a session identity field indicating an identity of an application-layer control session to which the application-layer control message belongs. In some embodiments, each of the application-layer control messages received is configurable to include one or more linking fields that link the identified application-layer control session with another application-layer control session. The law enforcement device is also configured to receive, over the handover interface, signaling indicating which application-layer control messages belong to application-layer control sessions that are linked to one another.

In some embodiments, the law enforcement device is configured to perform the steps described above for a law enforcement device.

Other embodiments herein include a computer program comprising instructions which, when executed by at least one processor of a network mediation device, causes the network mediation device to perform the steps described above for a network mediation device. Other embodiments herein include a computer program comprising instructions which, when executed by at least one processor of a law enforcement device, causes the law enforcement device to perform the steps described above for a law enforcement device. In one or more of these embodiments, a carrier containing the computer program is one of an electronic signal, optical signal, radio signal, or computer readable storage medium.

Other embodiments herein include a network mediation device configured for use in a communication network. The network mediation device comprises communication circuitry and processing circuitry. The processing circuitry is configured to receive, at the network mediation device, application-layer control messages intercepted in the communication network as part of a lawful interception service. In some embodiments, each of the application-layer control messages received is configurable to include a session identity field indicating an identity of an application-layer control session to which the application-layer control message belongs. In some embodiments, each of the application-layer control messages received is configurable to include one or more linking fields that link the identified application-layer control session with another application-layer control session. The processing circuitry is also configured to send, over a handover interface from the network mediation device towards a law enforcement device, the application-layer control messages and signaling indicating which application-layer control messages belong to application-layer control sessions that are linked to one another.

In some embodiments, the processing circuitry is configured to perform the steps described above for a network mediation device.

Other embodiments herein include a law enforcement device comprising communication circuitry and processing circuitry. The processing circuitry is configured to receive, over a handover interface from a network mediation device in a communication network, application-layer control messages intercepted in the communication network as part of a lawful interception service. In some embodiments, each of the application-layer control messages received is configurable to include a session identity field indicating an identity of an application-layer control session to which the application-layer control message belongs. In some embodiments, each of the application-layer control messages received is configurable to include one or more linking fields that link the identified application-layer control session with another application-layer control session. The processing circuitry is also configured to receive, over the handover interface, signaling indicating which application-layer control messages belong to application-layer control sessions that are linked to one another.

In some embodiments, the processing circuitry is configured to perform the steps described above for a law enforcement device.

Other embodiments herein include a non-transitory computer-readable storage medium on which is stored instructions that, when executed by a processor of a network mediation device in a communication network, causes the network mediation device to receive, at the network mediation device, application-layer control messages intercepted in the communication network as part of a lawful interception service. In some embodiments, each of the application-layer control messages received is configurable to include a session identity field indicating an identity of an application-layer control session to which the application-layer control message belongs. In some embodiments, each of the application-layer control messages received is configurable to include one or more linking fields that link the identified application-layer control session with another application-layer control session. In some embodiments, a non-transitory computer-readable storage medium on which is stored instructions that, when executed by a processor of a network mediation device in a communication network, causes the network mediation device to send, over a handover interface from the network mediation device towards a law enforcement device, the application-layer control messages and signaling indicating which application-layer control messages belong to application-layer control sessions that are linked to one another.

Other embodiments herein include a non-transitory computer-readable storage medium on which is stored instructions that, when executed by a processor of a law enforcement device, causes the law enforcement device to receive, over a handover interface from a network mediation device in a communication network, application-layer control messages intercepted in the communication network as part of a lawful interception service. In some embodiments, each of the application-layer control messages received is configurable to include a session identity field indicating an identity of an application-layer control session to which the application-layer control message belongs. In some embodiments, each of the application-layer control messages received is configurable to include one or more linking fields that link the identified application-layer control session with another application-layer control session. In some embodiments, a non-transitory computer-readable storage medium on which is stored instructions that, when executed by a processor of a law enforcement device, causes the law enforcement device to receive, over the handover interface, signaling indicating which application-layer control messages belong to application-layer control sessions that are linked to one another.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a communication network configured for lawful interception according to some embodiments.

FIG. 2 is a block diagram of a communication network configured for lawful interception according to other embodiments.

FIGS. 3A-3B are block diagrams of an example for signaling over a handover interface according to some embodiments.

FIG. 4 is a logic flow diagram of a method performed by a network mediation device according to some embodiments.

FIG. 5 is a logic flow diagram of a method performed by a law enforcement device according to some embodiments.

FIG. 6 is a block diagram of a network mediation device according to some embodiments.

FIG. 7 is a block diagram of a law enforcement device according to some embodiments.

FIG. 8 is a block diagram of a communication system in accordance with some embodiments

FIG. 9 is a block diagram of a user equipment according to some embodiments.

FIG. 10 is a block diagram of a network node according to some embodiments.

FIG. 11 is a block diagram of a host according to some embodiments.

FIG. 12 is a block diagram of a virtualization environment according to some embodiments.

FIG. 13 is a block diagram of a host communicating via a network node with a UE over a partially wireless connection in accordance with some embodiments.

### DETAILED DESCRIPTION

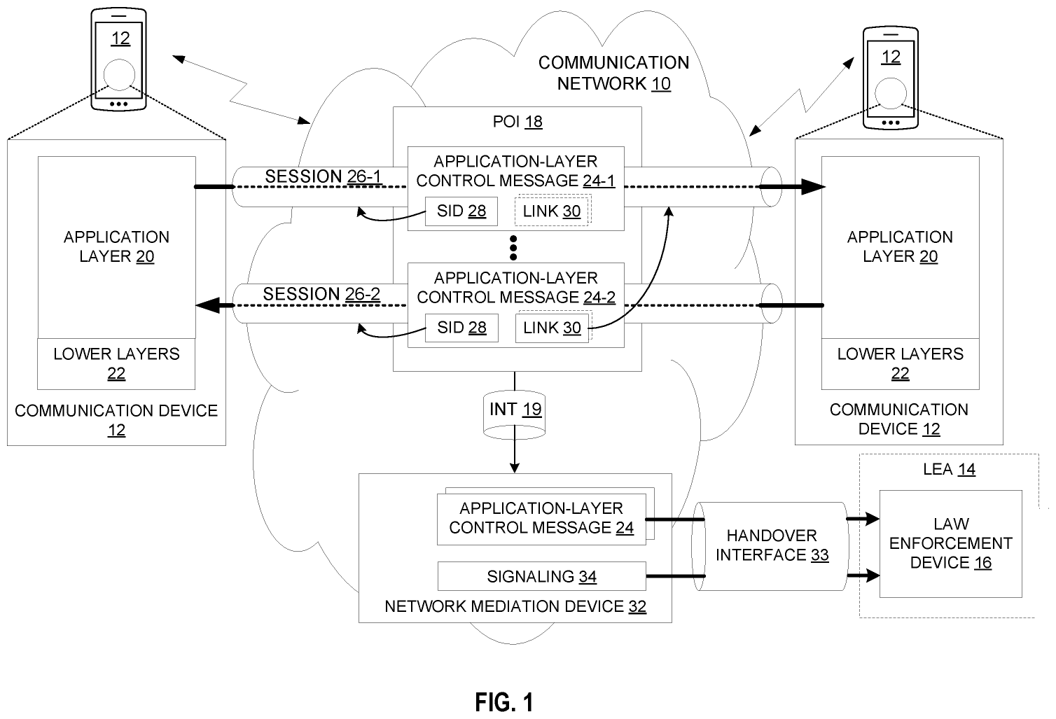

FIG. 1 shows a communication network 10 of a communication service provider (CSP) according to some embodiments. The communication network 10 provides communication service to communication devices, two of which is shown as communication devices 12. In the specific example of FIG. 1, the communication network 10 is a wireless communication network, in which case the communication network 10 provides the communication service over a wireless communication interface with communication devices.

The communication network 10 as shown provides a lawful interception (LI) service to a law enforcement agency (LEA) 14. The communication network 10 in this regard intercepts data pursuant to lawful authority, e.g., a warrant, and provides the intercepted data to a law enforcement device 16 associated with the LEA 14, for the purpose of analysis or evidence. The law enforcement device 16 may be, or be comprised in, a law enforcement monitoring facility, where the law enforcement monitoring facility is designated as the transmission destination for the results of interception relating to a particular interception subject, e.g., as specified according to ETSI TS 101 671 V3.15.1 (2018 June).

In some embodiments, the data that the communication network 10 intercepts as part of LI includes copies of the content of communications transmitted between the communication devices 12. The content of communications may, for example, include any material or information concerning the substance, purport, or meaning of the communications. Alternatively or additionally, the intercepted data may include material or information related to the interception of communications transmitted between the communication devices 12. Such intercepted-related information (IRI) may for example include dialing, signaling, or addressing information that identifies the origin, direction, destination, or termination of each communication generated or received by a subscriber by means of any equipment, facility, or service of a service provider. This may include for instance parameters of the signaling information that can be used as a means to subscribe to or activate features of the service, or establish and control a communication attempt. Generally, then, in some embodiments, the data that the communication network 10 intercepts may include copies of network traffic that contain material related to IRI or material related to IRI and the content of communications.

FIG. 1 shows that a point of intercepted (POI) 18 in the communication network 10 intercepts data in this way as part of LI. The POI 18 may be a physical, logical, or functional point at which data is intercepted. The POI 18 may for instance be, or be hosted at, an access element, a network connectivity element, or a service element in the communication network 10, e.g., as defined in ETSI TR 101 944. In embodiments where the communication network 10 has a service-based architecture with a set of interconnected network functions (NFs), the POI 18 may be a sub-function of an NF in the communication network 10, e.g., where each NF may implement one or more POIs. Where the communication network 10 is a 5G network, for instance, the communication network 10 may include NFs such as an Access and Mobility Function (AMF), a Session Management Function (SMF), a User Data Management (UDM) function, etc., in which case the POI 18 may be a sub-function of an AMF, SMF, UDM, etc.

FIG. 1 shows the POI 18 as intercepting data at an application layer. As shown, for instance, each wireless communication device 12 implements a protocol stack for communication, with an application layer 20 being above lower layers 22 (e.g., a Transport layer, a Physical Layer, etc.) in the protocol stack. The POI 18 in some embodiments intercepts data at this application layer 20. In doing so, the POI 18 may produce intercepted data in the form of application-layer messages, which may for instance correspond to application layer transactions or application-layer protocol data units (PDUs).

FIG. 1 in particular shows that the POI 18 intercepts application-layer messages that are messages of an application-layer control protocol. Such messages are thereby appropriately referred to as application-layer control messages 24, two of which are shown as application-layer control messages 24-1 and 24-2. In some embodiments, the application-layer control messages 24 are Session Initiation Protocol (SIP) messages. In these and other embodiments, the application-layer control messages 24 may be messages of an asynchronous communication service, e.g., messages for a Short Messaging Service (SMS) or messages for any messaging services deployed in an IP Multimedia Subsystem (IMS) network.

Each application-layer control message 24 belongs to a respective application-layer control session 26. The application-layer control protocol governs what constitutes an application-layer control session 26, e.g., when an existing application-layer control session ends and when a new application-layer control session begins. Each application-layer control message 24 in this regard is configurable to include a so-called session identity field (SID) 28 indicating an identity of the application-layer control session 26 to which the application-layer control message 24 belongs. As shown, for instance, application-layer control message 24-1 includes a SID field 28 indicating that the application-layer control message 24-1 belongs to application-layer control session 26-1, e.g., in the sense that application-layer control message 24-1 is communicated during, in, or as part of that application-layer control session 26-2. And application-layer control message 24-2 includes a SID field 28 indicating that the application-layer control message 24-2 belongs to application-layer control session 26-2.

At least some of the individual application-layer control sessions 26 may nonetheless be linked to one another, e.g., where the linking may be one-way or two-way. Application-layer control session 26-2 may for example be linked to application-layer control session 26-1 in the sense that an application-layer control message 24-2 which belongs to application-layer control session 26-2 is substantively, logically, and/or procedurally related to an application-layer control message 24-1 which belongs to application-layer control session 26-1. For instance, application-layer control session 26-2 may be linked to application-layer control session 26-1 if an application-layer control message 24-2 belonging to application-layer control session 26-2 is a response to an application-layer control message 24-1 belonging to application-layer control session 26-1. No matter the particular basis for linking of application-layer control sessions 26, though, in some embodiments linking of application-layer control sessions 26 is governed by the application-layer control protocol, e.g., so as to be application-specific and/or service-specific.

The application-layer control protocol according to embodiments herein further records linking of application-layer controls sessions 26 in the application-layer control messages 24. Each application-layer control message 24 in this regard is configurable to include one or more linking fields 30 that link the application-layer control session 26 to which the message 24 belongs with another application-layer control session 26. As shown in FIG. 1, for instance, the application-layer control session 26-2 to which application-layer control message 24-2 belongs is linked to the application-layer control session 26-1 to which application-layer control message 24-1 belongs, e.g., on the basis of application-layer control message 24-2 being a response to application-layer control message 24-1. Accordingly, application-layer control message 24-2 includes one or more linking fields 30 that link application-layer control session 26-2 to application-layer control session 26-1. The one or more linking fields 30 included in application-layer control message 24-2 may for example indicate an identity of application-layer control session 26-2. In some embodiments, then, as shown in FIG. 1, for an application-layer control message 24-2 that is a response to a previous application-layer control message 24-1, the one or more linking fields 30 included in that application-layer control message 24-2 indicate an identity of the application-layer control session 26-1 to which the previous application-layer control message 24-1 belongs. Note that, in some embodiments, the one or more linking fields 30 are optional and can be excluded if no linking need be indicated, e.g., for the first message that is not in response to any other message.

Consider an example in which the application-layer control protocol is the Session Initiation Protocol (SIP) such that the application-layer control messages 24 are SIP messages. In one such embodiment, each application-layer control session 26 corresponds to a SIP call leg. A SIP call may refer to a collection of one or more SIP call legs, where a SIP call leg refers to a one-to-one signaling relationship between two SIP user agents. In this context, the session identity (SID) field 28 may be a Call-ID field. The Call-ID field's value may be set to a cryptographically random identifier which is unique across SIP call legs. In some embodiments, as may be the case when the SIP messages are for an asynchronous communication service, there may be a single application-layer control session for each SIP call leg.

In some SIP-based embodiments where the SID field 28 is a Call-ID field, the one or more linking fields 30 include an In-Reply-To field. In this case, the In-Reply-To field of a SIP message indicates one or more other SIP call legs to which the SIP call leg identified by the Call-ID field of the same SIP message is in reply. That is, the SIP call leg identified by the Call-ID field is linked to the one or more other SIP call legs in the sense that the SIP call leg is in reply to (e.g., references or returns) the one or more other SIP call legs. In some embodiments, the In-Reply-To field indicates these one or more other SIP call legs by enumerating one or more respective Call-IDs which identify those one or more other SIP call legs.

No matter the particular type of application-layer control messages 24, though, the POI 18 provides the application-layer control messages 24 (as intercepted) to a network mediation device 32, e.g., which may implement or host a mediation and delivery function (MDF) as defined by ETSI TS 103 221-2 V1.4.1. The POI 18 may for example encapsulate the application-layer control messages 24 into PDUs defined for an interface 19 between the POI 18 and then send a binary stream of the PDUs to the network mediation device 32 over the interface 19, e.g., where each PDU may contain one or more application-layer control messages 24 as well as a set of header fields and/or a set of attributes for conveying identifiers, routing information, correlation information, and/or metadata about the application-layer control message(s) 24. In one embodiment, for instance, the interface 19 between the POI 18 and the network mediation device 32 may be an X2 interface or an X3 interface, e.g., as specified by ETSI TS 103 221-2 V1.4.1.

In receipt of the application-layer control messages 24 from the POI 18, e.g., as encapsulated in PDUs defined for the interface 19, the network mediation device 32 performs any necessary translation, correlation, and/or mediation for onward handover of the intercepted application-layer control messages 24 to the law enforcement device 16. The network mediation device 32 in this regard sends the application-layer control messages 24 over a handover interface 33 towards the law enforcement device 16.

Some embodiments herein enhance the handover interface 33 with signaling 34 that indicates which intercepted application-layer control messages 24 belong to application-layer control sessions 26 that are linked to one another. The network mediation device 32 may for example determine which application-layer control messages 24 belong to application-layer control sessions 26 that are linked to one another, based on the session identity field 28 and the linking field(s) 30 of the application-layer control message 24, and then generate the signaling 34 accordingly. In one embodiment, for instance, the network mediation device 32 generates the signaling 34 to indicate different values for different groups of application-layer control messages 24 which belong to different groups of application-layer control sessions 26 that are linked.

The signaling 34 in embodiments herein may thereby enable the law enforcement device 16 to discriminate the intercepted application-layer control messages 24 based on which groups of application-layer control sessions 26 are linked, e.g., alternatively or additionally to discriminating the application-layer control messages 24 based on to which individual application-layer control sessions 26 the messages 24 belong. The law enforcement device 16 may for example process the application-layer control messages 24 based on which application-layer control messages 24 belong to application-layer control sessions 26 that are linked to one another (according to the signaling 34). With the signaling 34 indicating this directly, the law enforcement device 16 need not perform additional processing to deduce which application-layer control messages 24 belong to application-layer control sessions 26 that are linked to one another. Some embodiments thereby advantageously reduce the complexity, inefficiency, and/or cost of analyzing the intercepted application-layer control messages 24 at the law enforcement device 16.

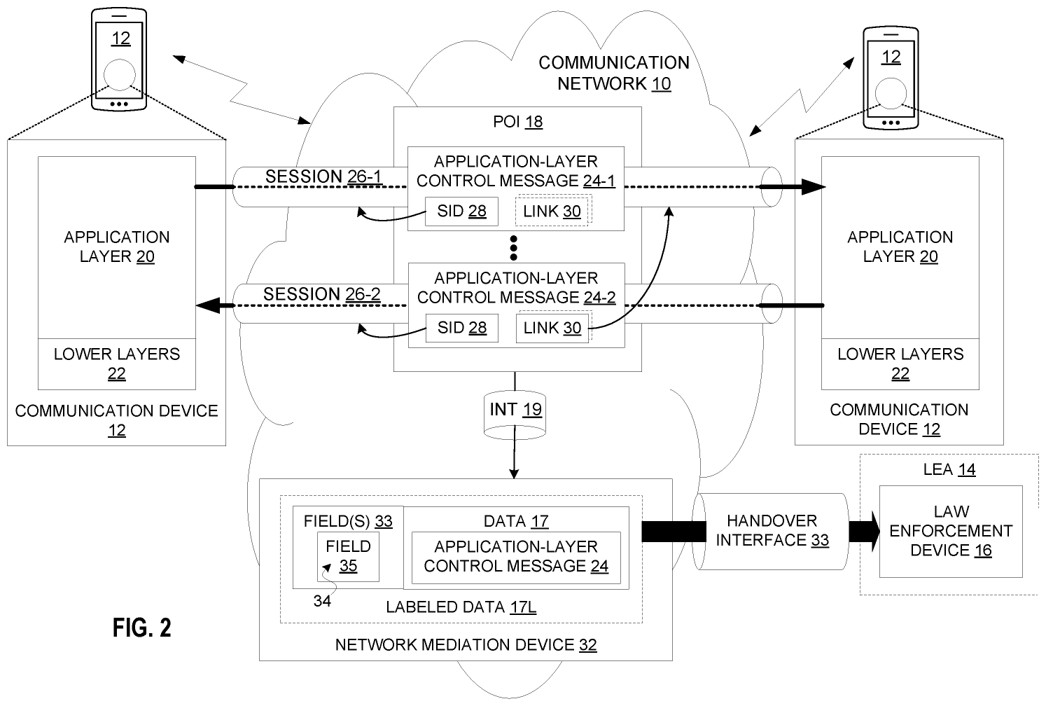

FIG. 2 shows additional details of the signaling 34 according to some embodiments. As shown, the POI 18 transmits, to the network mediation device 32, intercepted data 17 that conveys the application-layer control messages 24. The intercepted data 17 may for instance comprise a stream of PDUs defined on interface 19, where each PDU encapsulates a respective one of the application-layer control messages 24. For each application-layer control message 24, the network mediation device 32 labels the data 17 encapsulating that message 24 with a set of one or more fields 33, e.g., within a packet switched (PS) header. By labeling the data 17 encapsulating an application-layer control message 24 with this set of field(s) 33, the network mediation device 32 effectively labels each application-layer control message 24 with the set of field(s) 33. The set of field(s) 33 may allow the intercepted data 18 to be identified, ordered, etc. over the handover interface 33. In some embodiments as shown, the field(s) 33 are prepended to the intercepted data 18 in the form of a header, although the field(s) 33 may be added anywhere (e.g., in a footer) or as part of an overall enveloping process. No matter the particular type or location of the added field(s) 33, by labeling the intercepted data 18 and thereby the application-layer control messages 24 in this way, the network mediation device 22 produces labeled data 17L, e.g., conditioned for transport over the handover interface 33. In embodiments where the intercepted data 17 comprises a stream of PDUs defined on interface 19, for instance, the labeled data 17L may take the form of a stream of PDUs defined on the handover interface 33 for conveying the application-layer control messages 24. Regardless, the network mediation device 22 then sends the labeled data 17L over the handover interface 33 towards the law enforcement device 16.

In this context, the signaling 34 indicating which application-layer control messages 24 belong to application-layer control sessions 26 that are linked to one another is generated in FIG. 2 as one of the field(s) 33, shown as field 35. The field 35 may therefore be a field defined on the handover interface 33, such that which application-layer control messages 24 belong to application-layer control sessions 26 that are linked to one another is directly indicated at the handover interface level. In these and other embodiments, the network mediation device 22 may send the application-layer control messages 24 and the signaling 34 over the handover interface 33 by sending the labeled data 17L (and thereby the application-layer control messages 24) as labeled with the field 35 over the handover interface 33.

In any event, the signaling 34 in this regard may comprise the value of the field 35 across the application-layer control messages 24 as labeled, e.g., the value of the field 35 across the application-layer control messages 24 indicates which application-layer control messages 24 belong to application-layer control sessions 26 that are linked to one another. For example, in some embodiments, the network mediation device 32 sets the field 33 to have the same value across application-layer control messages 24 which belong to application-layer control sessions 26 that are linked to one another and to have different values across application-layer control messages 24 which belong to application-layer control sessions 26 that are not linked to one another. The network mediation device 32 may do so based on storing, for each application-layer control message, a mapping between the value to which the field 33 is set for the application-layer control message and the identity of the application-layer control session to which the application-layer control message belongs according to the session identity field included in the application-layer control message.

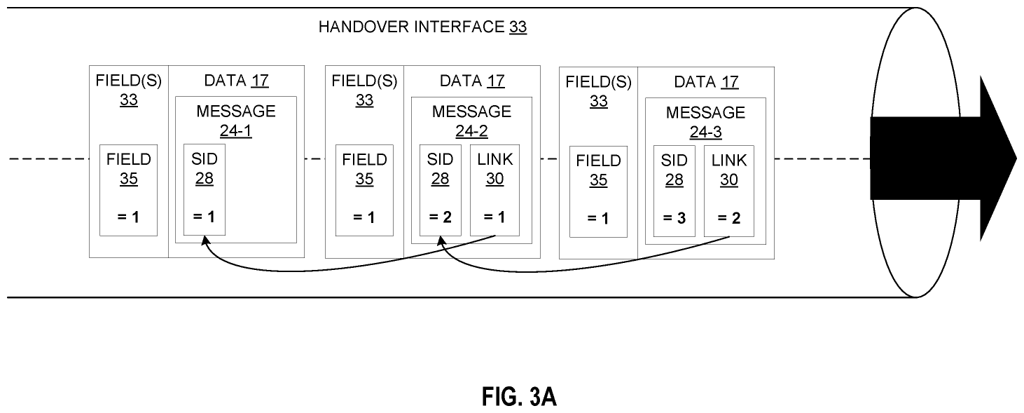

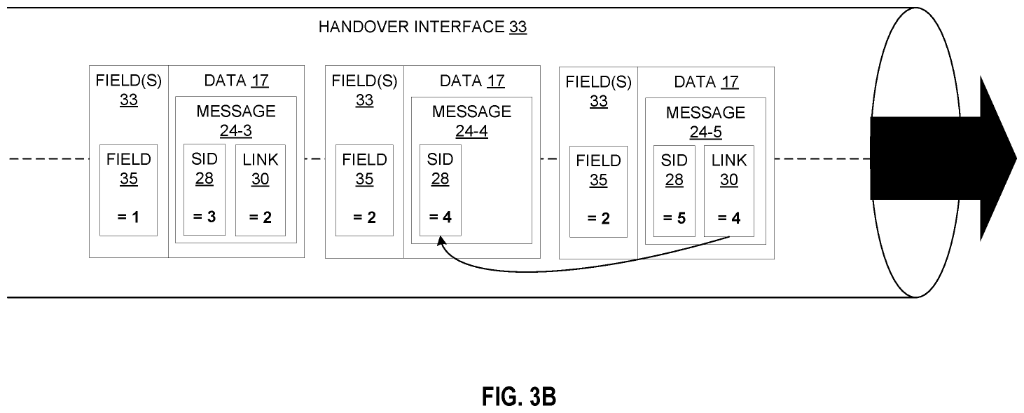

FIGS. 3A-3B illustrate one example. As shown in FIG. 3A, the network mediation device 22 receives intercepted data 17 that conveys application-layer control message 24-1. Application-layer control message 24-1 includes a session identity field 28 with a value of 1, so as to indicate that the application-layer control message 24-1 belongs to an application-layer control session 26 with an identity equal to 1. Application-layer control message 24-1 does not include linking field(s) 30, as the application-layer control session 26 with an identity of 1 is not linked to any other application-layer control session. The network mediation device 22 labels the data 17 conveying application-layer control message 24-1 with a field 35 and sets the value of the field 35 to 1 before sending the data 17 as labeled over the handover interface 33.

FIG. 3A shows that the network mediation device 22 also receives intercepted data 17 that conveys application-layer control message 24-2. Application-layer control message 24-2 includes a session identity field 28 with a value of 2, so as to indicate that the application-layer control message 24-2 belongs to a different application-layer control session 26; namely, a session with an identity equal to 2. Application-layer control message 24-2 does include linking field(s) 30 set to a value of 1, so as to indicate that the application-layer control session 26 with an identity of 2 is linked to an application-layer control session 26 with an identity of 1. The network mediation device 22 similarly labels the data 17 conveying application-layer control message 24-2 with a field 35 and sets the value of the field 35 to 1 before sending the data 17 as labeled over the handover interface 33.

FIG. 3A further shows that the network mediation device 22 receives intercepted data 17 that conveys application-layer control message 24-3. Application-layer control message 24-3 includes a session identity field 28 with a value of 3, so as to indicate that the application-layer control message 24-3 belongs to a yet another application-layer control session 26; namely, a session 26 with an identity equal to 3. Application-layer control message 24-3 includes linking field(s) 30 set to a value of 2, so as to indicate that the application-layer control session 26 with an identity of 3 is linked to an application-layer control session 26 with an identity of 2. The network mediation device 22 similarly labels the data 17 conveying application-layer control message 24-3 with a field 35 and sets the value of the field 35 to 1 before sending the data 17 as labeled over the handover interface 33.

The field 35 being set to the same value (“1”) across application-layer control messages 24-1, 24-2, and 24-3 indicates that those application-layer control messages 24-1, 24-2, and 24-3 belong to application-layer control sessions 26 that are linked to one another. Indeed, the application-layer control session 26 with an identity of 2 is directly linked to the application-layer control session 26 with an identity of 1, the application-layer control session 26 with an identity of 3 is directly linked to the application-layer control session 26 with an identity of 2, and thereby the application-layer control session 26 with an identity of 3 is indirectly linked to the application-layer control session 26 with an identity of 1.

Continuing the example in FIG. 3B, the network mediation device 22 also receives intercepted data 17 that conveys application-layer control message 24-4. Application-layer control message 24-4 includes a session identity field 28 with a value of 4, so as to indicate that the application-layer control message 24-4 belongs to an application-layer control session 26 with an identity equal to 4. Application-layer control message 24-4 does not include linking field(s) 30, as the application-layer control session 26 with an identity of 4 is not linked to any other application-layer control session. The network mediation device 22 labels the data 17 conveying application-layer control message 24-4 with a field 35 and sets the value of the field 35 to 2 before sending the data 17 as labeled over the handover interface 33.

FIG. 3B shows that the network mediation device 22 also receives intercepted data 17 that conveys application-layer control message 24-5. Application-layer control message 24-5 includes a session identity field 28 with a value of 5, so as to indicate that the application-layer control message 24-5 belongs to a different application-layer control session 26; namely, a session with an identity equal to 5. Application-layer control message 24-5 does include linking field(s) 30 set to a value of 4, so as to indicate that the application-layer control session 26 with an identity of 5 is linked to an application-layer control session 26 with an identity of 4. The network mediation device 22 similarly labels the data 17 conveying application-layer control message 24-5 with a field 35 and sets the value of the field 35 to 2 before sending the data 17 as labeled over the handover interface 33.

The field 35 being set to the same value (“2”) across application-layer control messages 24-4 and 24-5 indicates that those application-layer control messages 24-4 and 24-5 belong to application-layer control sessions 26 that are linked to one another. By contrast, the field 35 is set to have different values across application-layer control messages 24-3 and 24-4 because those application-layer control messages 24-3 and 24-4 belong to application-layer control sessions that are not linked to one another, i.e., session 4 is not linked to session 3. Similarly, the field 35 is set to have different values across application-layer control messages 24-3 and 24-5 because those application-layer control messages 24-3 and 24-5 belong to application-layer control sessions that are not linked to one another, i.e., session 5 is also not linked to session 3.

Some embodiments herein are applicable in the case where the handover interface 33 is specified by ETSI, e.g., according to ETSI TS 102 232 parts, ETSI TS 103 120, and ETSI TS 103 221-1 defining the data 17 intercepted per service (e.g., Messaging services, L2 services, Internet Access Service, IP Multimedia and Mobile services). In one or more such embodiments, the signaling 34 herein may be implemented as a field within a PSHeader as specified by ETSI TS 102 232 parts. The value of the field may be set as described above to indicate which application-layer control messages 24 belong to application-layer control sessions 26 that are linked to one another, regardless of the service for which data was intercepted in the communication network 10 and/or regardless of network conditions. In some embodiments as described below, the network mediation device 32 is exemplified as implementing an MDF.

In some embodiments, for example, the MDF receives intercepted data 17 (conveying application-layer control messages 24) from the POI 18 and labels the intercepted data 17 with a PSHeader as shown below, with the intercepted data 17 constituting the payload of the PS-PDU.

| PS-PDU ::= SEQUENCE | |
|---|---|
| { | |
| pSHeader | [1] PSHeader, |
| payload | [2] Payload |

}

In some embodiments, the PSHeader is as shown below, where the signaling 34 is exemplified as a so-called “extendedSession” field in the PSHeader:

PSHeader ::= SEQUENCE
{

| | |
|---|---|
| li-psDomainId | [0] OBJECT IDENTIFIER, |
| lawfulInterceptionIdentifier | [1] LawfulInterceptionIdentifier, |
| authorizationCountryCode | [2] PrintableString (SIZE (2)) OPTIONAL, |
| communicationIdentifier | [3] CommunicationIdentifier, |
| sequenceNumber | [4] INTEGER (0..4294967295), |
| timeStamp | [5] GeneralizedTime OPTIONAL, |
| interceptionPointID | [6] PrintableString (SIZE (1..8)) OPTIONAL, |
| microSecondTimeStamp | [7] MicroSecondTimeStamp OPTIONAL, |
| timeStampQualifier | [8] TimeStampQualifier OPTIONAL, |
| extendedSession | [9] OCTET STRING OPTIONAL |

}

For example, the signaling 34 may comprises the value of the extendedSession field across the application-layer control messages 24. In these embodiments, then, the communicationIdentifier field may identify the individual application-layer control session 26 to which an application-layer control message 24 belongs, e.g., where the definition of each application-layer control session 26 may be service-specific. And the extendedSession field then indicates which application-layer control messages 24 belong to application-layer control sessions 26 that are linked to one another, e.g., such that the extendedSession field indicates correlation between the service-specific application-layer control sessions 26. In some embodiments, the extendedSession field is an optional field.

Consider an example where the application-layer control messages 24 are SIP messages for an asynchronous communication service, such as for SMS in an Internet Protocol Multimedia Subsystem (IMS) as specified by ETSI TS 124 341 as a service. In such a case, user equipments (UEs) may exemplify the wireless communication devices 12 in FIG. 1. The SMS may start when a UE sends a SIP message to the wireless communication network, whereupon the network 10 forwards the SIP message to the destination UE. The SIP message, as an example of an application-layer message 24, may be exemplified as below:
MESSAGE sip:+xxxx500@ims.mnc053.mcc228.3gppnetwork.org;user=phone SIP/2.0
To: &lt;sip:+xxxx500@ims.mnc053.mcc228.3gppnetwork.org&gt;
From: &lt;sip:+xxxx985@ims.mnc053.mcc228.3gppnetwork.org&gt;;tag=h7g4Esbg_a88d0e4f
Call-ID: Igm6SXMFChda80Jy7b84wA . . . @10.10.10.10
   Here, the SIP message includes a header with a Call-ID field that exemplifies the session identity field 28 in FIG. 1. The Call-ID field in this regard identifies a SIP call leg as an example of an individual application-layer control session 26.

The destination UE may transmit a SIP message in response, as another example of an application-layer message 24:
MESSAGE sip:+xxxx985@ims.mnc053.mcc228.3gppnetwork.org SIP/2.0
To: &lt;sip:+xxxx985@ims.mnc053.mcc228.3gppnetwork.org&gt;
From: &lt;sip:nl4ipsmgw12.ims.mnc053.mcc228.3gppnetwork.org&gt;;tag=3bbe1eaa
Call-ID: 96309f42b0221fc13a29b6c0d88d9ba1@10.10.10.10
CSeq: 1 MESSAGE
Max-Forwards: 70
Content-Length: 13
Via: SIP/2.0/UDP 10.10.10.10:5060;branch=z9hG4bK-3336-357b36a572dc692338b629c61361cd67
Content-Type: application/vnd.3gpp.sms
Accept-Contact: *;+g.3gpp.smsip;require;explicit
P-Asserted-Identity: &lt;sip:nl4ipsmgw12.ims.mnc053.mcc228.3gppnetwork.org&gt;
In-Reply-To: Igm6SXMFChda80Jy7b84wA . . . @10.10.10.10

The response message includes a header with the Call-ID field set to a different value. Indeed, the Call-ID value is different per each asynchronous communication message belonging to the same SMS service, e.g., such that each message is accepted as a unique session. That is, there may be a separate session for each leg in the asynchronous communication service, whereby the session is tied to a specific service leg.

The response message as shown also includes an In-Reply-To parameter in the header, where the In-Reply-To parameter exemplifies the linking field(s) 30 in FIG. 1. The In-Reply-To parameter contains the same Call-ID value of the originating message. The Call-ID value thereby generally indicates a single session in a chain of sessions, and the In-Reply-To parameter correlates sessions in the session chain.

In this example, the network mediation device 32 uses the Call-ID parameter and the In-Reply-To parameter to fill or set the extendedSession field on the handover interface 33. In some embodiments, for example, the network mediation device 32 calculates the value of the extendedSession parameter for the first SIP message intercepted as part of a first SIP call leg and then uses that same value for any other SIP messages intercepted as part of any other linked SIP call legs, e.g., for all other SIP messages intercepted during the interception of the SMS service. In one embodiment in this regard, the network mediation device 32 may tie the value of the extendedSession parameter to a service expiration timer which governs when a service is deemed to have timed out, e.g., where the service expiration timer may be configured based on a specific service on a specific communication service provider deployment.

More particularly, in some embodiments, the network mediation device 32 stores the couple [“Call-ID”, “extendedSession”] for the first SIP message intercepted. The value of “extendedSession” is a counter that will be increased at each new SMS service interception, e.g., as determined according to a service expiration timer. When a new SMS message is intercepted, the “In-Reply-To” field is detected and the network mediation device 32 verifies if the header contains the Call-ID number fetched from the internal cache according to the previous step. If case of a match, the network mediation device 32 gets the “extendedSession” value from the cache and provides it towards the handover interface 33 for the new SMS message. All subsequent SMS messages belonging to the same communication service will be filled with the same “extendedSession” value. In some embodiments, the “extendedSession” value will be time-valid according to a specific policy defined by the communication service provider for the specific service.

In some embodiments, the network mediation device 32 will additionally set the value of the communicationIdentifier field to the value of the Call-ID parameter.

Generally, then, whereas the service provider may indicate a separate session for each leg in an asynchronous communication service, by providing different Call-ID values for different legs, the network mediation device 32 may correlate those separate legs/sessions in order to indicate a value for the “extendedSession” parameter that is common to the legs/sessions forming the whole asynchronous communication service. That is, the “extendedSession” parameter ties all legs belonging to the same communication service via a specific value for the parameter. The “extendedSession” parameter may thereby effectively indicate one unique session for the whole service. The law enforcement device 16 may advantageously exploit this “extendedSession” parameter to reconstruct the complete service functional flow, without having to engage in complex post-processing.

As this example demonstrates, some embodiments herein better support law enforcement agencies for lawful interception. Exploiting signaling 34 herein, some embodiments even enable law enforcement agencies to interpret the intercepted data in this way for existing services (e.g., SMS) as well as future services. Some embodiments do so without impacting the POI 18 or any other internal intercepting nodes, e.g., for SMS over IP service.

Although exemplified for SMS, some embodiments herein may be applied in a similar way for any other asynchronous communication service based on SIP. Alternatively or additionally, some embodiments herein may be applied to any interception domain scenario, e.g., 4G, 5G (with physical network elements interfacing MDF), or cloud implementation (with virtual network functions interfacing MDF). In some interception domain scenarios, the MDF (or MF/DF) will elaborate the X2/X3 data to manage properly the HI2/HI3 data sending according to the “extendedSession” gathering flow.

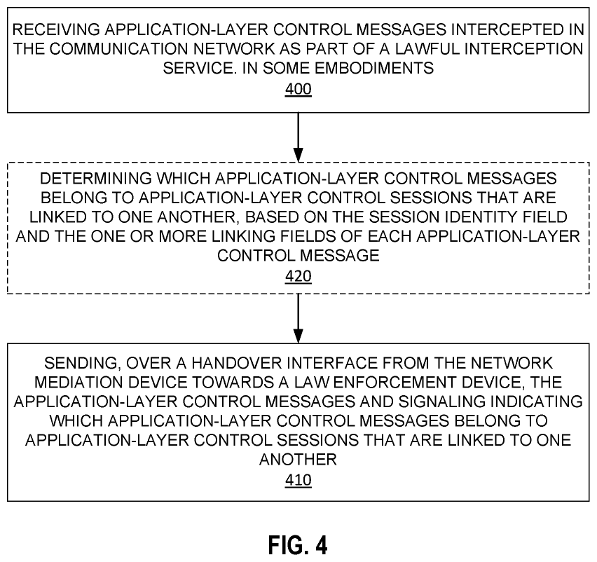

In view of the modifications and variations herein, FIG. 4 depicts a method performed by a network mediation device 32 in a communication network 10 in accordance with particular embodiments. The method includes receiving application-layer control messages 24 intercepted in the communication network 10 as part of a lawful interception service (Block 400). In some embodiments, each of the application-layer control messages 24 received is configurable to include: (i) a session identity field 28 indicating an identity of an application-layer control session 26 to which the application-layer control message 24 belongs; and (ii) one or more linking fields 30 that link the identified application-layer control session 26 with another application-layer control session 26. The method further comprises sending, over a handover interface from the network mediation device 32 towards a law enforcement device, the application-layer control messages 24 and signaling 34 indicating which application-layer control messages 24 belong to application-layer control sessions 26 that are linked to one another (Block 410).

In some embodiments, the method further comprises determining which application-layer control messages 24 belong to application-layer control sessions 26 that are linked to one another, based on the session identity field 28 and the one or more linking fields 30 of each application-layer control message 24 (Block 420).

In some embodiments, the method further comprises labeling each application-layer control message 24 with a field 35. In some embodiments, the signaling 34 comprises the value of the field 35 across the application-layer control messages 24 as labeled. In one embodiment, sending the application-layer control messages 24 and the signaling 34 comprises sending the application-layer control messages 24 as labeled with the field 35. In one or more of these embodiments, the method further comprises setting the field 35 to have the same value across application-layer control messages 24 which belong to application-layer control sessions 26 that are linked to one another and to have different values across application-layer control messages 24 which belong to application-layer control sessions 26 that are not linked to one another. In some embodiments, the field 35 is an extended session field which is different than a Communications Identity Number field in each application-layer control message 24. In other embodiments, the field 35 is a Communications Identity Number field whose value identifies a communications session.

In some embodiments, the application-layer control messages 24 are Session Initiation Protocol, SIP, messages. In one or more of these embodiments, an application-layer control session 26 corresponds to a SIP call leg. In some embodiments, the session identity field 28 is a Call-ID field, and the one or more linking fields 30 include an In-Reply-To field.

In some embodiments, for an application-layer control message 24 that is a response to a previous application-layer control message 24, the one or more linking fields 30 included in the application-layer control message 24 indicate an identity of an application-layer control session 26 to which the previous application-layer control message 24 belongs.

In some embodiments, the application-layer control messages 24 are messages of an asynchronous communication service.

In some embodiments, the application-layer control messages 24 are messages of a Short Messaging Service, SMS.

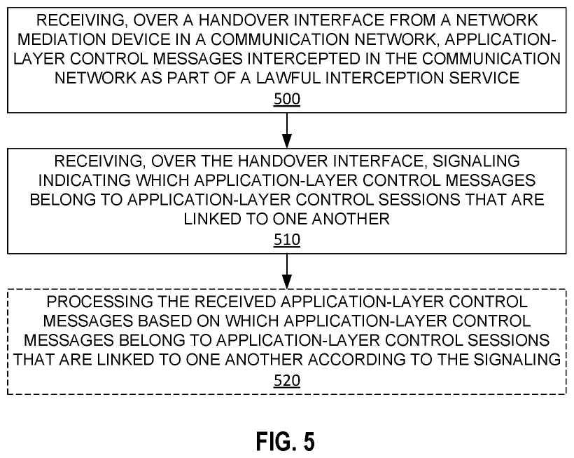

FIG. 5 depicts a method performed by a law enforcement device in accordance with other particular embodiments. The method comprises receiving, over a handover interface from a network mediation device 32 in a communication network 10, application-layer control messages 24 intercepted in the communication network 10 as part of a lawful interception service (Block 500). In some embodiments, each of the application-layer control messages 24 received is configurable to include a session identity field 28 indicating an identity of an application-layer control session 26 to which the application-layer control message 24 belongs. In some embodiments, each of the application-layer control messages 24 received is configurable to also include one or more linking fields 30 that link the identified application-layer control session 26 with another application-layer control session 26. The method also comprises receiving, over the handover interface, signaling 34 indicating which application-layer control messages 24 belong to application-layer control sessions 26 that are linked to one another (Block 510).

In some embodiments, the method further comprises processing the received application-layer control messages 24 based on which application-layer control messages 24 belong to application-layer control sessions 26 that are linked to one another according to the signaling 34 (Block 520).

In some embodiments, each application-layer control message 24 is labeled with a field.

In some embodiments, the signaling 34 comprises the value of the field 35 across the application-layer control messages 24 as labeled, and receiving the application-layer control messages 24 and the signaling 34 comprises receiving the application-layer control messages 24 as labeled with the field 35. In one or more of these embodiments, the field 35 has the same value across application-layer control messages 24 which belong to application-layer control sessions 26 that are linked to one another and has different values across application-layer control messages 24 which belong to application-layer control sessions 26 that are not linked to one another. In some embodiments, the field 35 is an extended session field which is different than a Communications Identity Number field in each application-layer control message 24. In other embodiments, the field 35 is a Communications Identity Number field whose value identifies a communications session.

In some embodiments, the application-layer control messages 24 are Session Initiation Protocol, SIP, messages. In one or more of these embodiments, an application-layer control session 26 corresponds to a SIP call leg. In some embodiments, the session identity field 28 is a Call-ID field, and the one or more linking fields 30 includes an In-Reply-To field.

In some embodiments, for an application-layer control message 24 that is a response to a previous application-layer control message 24, the one or more linking fields 30 included in the application-layer control message 24 indicate an identity of an application-layer control session 26 to which the previous application-layer control message 24 belongs.

In some embodiments, the application-layer control messages 24 are messages of an asynchronous communication service.

In some embodiments, the application-layer control messages 24 are messages of a Short Messaging Service, SMS.

Embodiments herein also include corresponding apparatuses. Embodiments herein for instance include a network mediation device 32 configured to perform any of the steps of any of the embodiments described above for the network mediation device 32.

Embodiments also include a network mediation device 32 comprising processing circuitry and power supply circuitry. The processing circuitry is configured to perform any of the steps of any of the embodiments described above for the network mediation device 32. The power supply circuitry is configured to supply power to the network mediation device 32.

Embodiments further include a network mediation device 32 comprising processing circuitry. The processing circuitry is configured to perform any of the steps of any of the embodiments described above for the network mediation device 32. In some embodiments, the network mediation device 32 further comprises communication circuitry.

Embodiments further include a network mediation device 32 comprising processing circuitry and memory. The memory contains instructions executable by the processing circuitry whereby the network mediation device 32 is configured to perform any of the steps of any of the embodiments described above for the network mediation device 32.

Embodiments herein also include a law enforcement device 16 configured to perform any of the steps of any of the embodiments described above for the law enforcement device 16.

Embodiments also include a law enforcement device 16 comprising processing circuitry and power supply circuitry. The processing circuitry is configured to perform any of the steps of any of the embodiments described above for the law enforcement device 16. The power supply circuitry is configured to supply power to the law enforcement device 16.

Embodiments further include a law enforcement device 16 comprising processing circuitry. The processing circuitry is configured to perform any of the steps of any of the embodiments described above for the law enforcement device 16. In some embodiments, the law enforcement device 16 further comprises communication circuitry.

Embodiments further include a law enforcement device 16 comprising processing circuitry and memory. The memory contains instructions executable by the processing circuitry whereby the law enforcement device 16 is configured to perform any of the steps of any of the embodiments described above for the law enforcement device 16.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

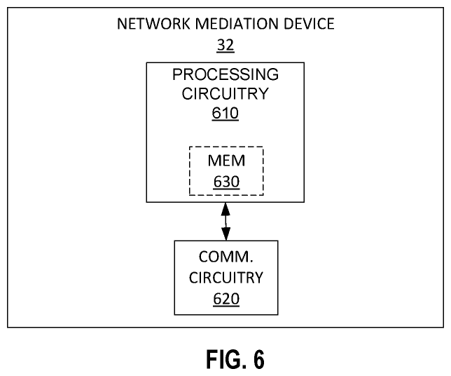

FIG. 6 for example illustrates a network mediation device 32 as implemented in accordance with one or more embodiments. As shown, the network mediation device 32 includes processing circuitry 610 and communication circuitry 620. The communication circuitry 620 (e.g., radio circuitry) is configured to transmit and/or receive information to and/or from one or more other nodes, e.g., via any communication technology. The processing circuitry 610 is configured to perform processing described above, e.g., in FIG. 4, such as by executing instructions stored in memory 630. The processing circuitry 610 in this regard may implement certain functional means, units, or modules.

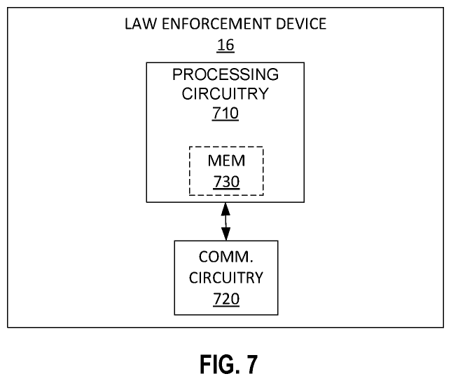

FIG. 7 illustrates a law enforcement device 16 as implemented in accordance with one or more embodiments. As shown, the law enforcement device 16 includes processing circuitry 710 and communication circuitry 720. The communication circuitry 720 is configured to transmit and/or receive information to and/or from one or more other nodes, e.g., via any communication technology. The processing circuitry 710 is configured to perform processing described above, e.g., in FIG. 5, such as by executing instructions stored in memory 730. The processing circuitry 710 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

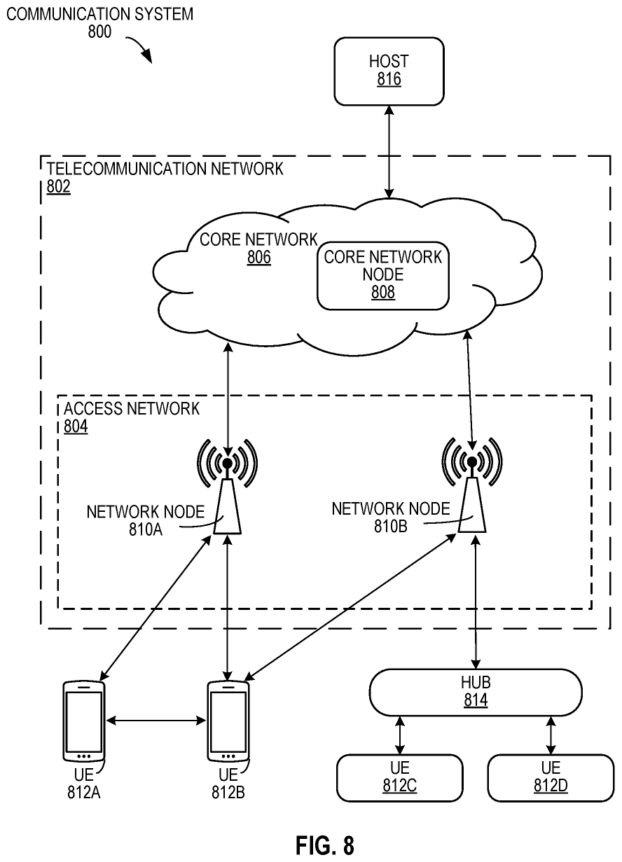

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3^{rd} Generation Partnership Project (3GPP) access node or non-3GPP access point. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy loT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

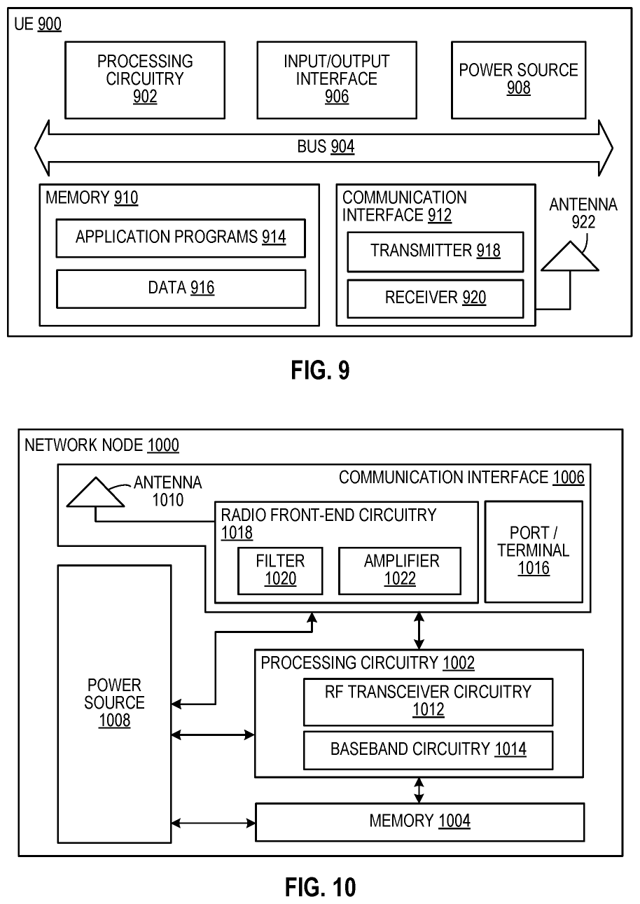

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an loT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an loT device comprises circuitry and/or software in dependence of the intended application of the loT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory

(ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

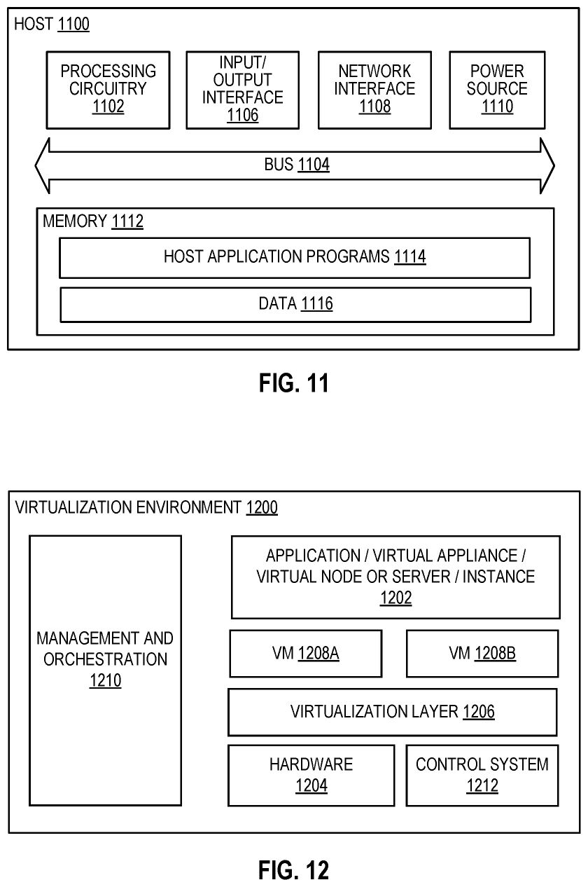

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE.

Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

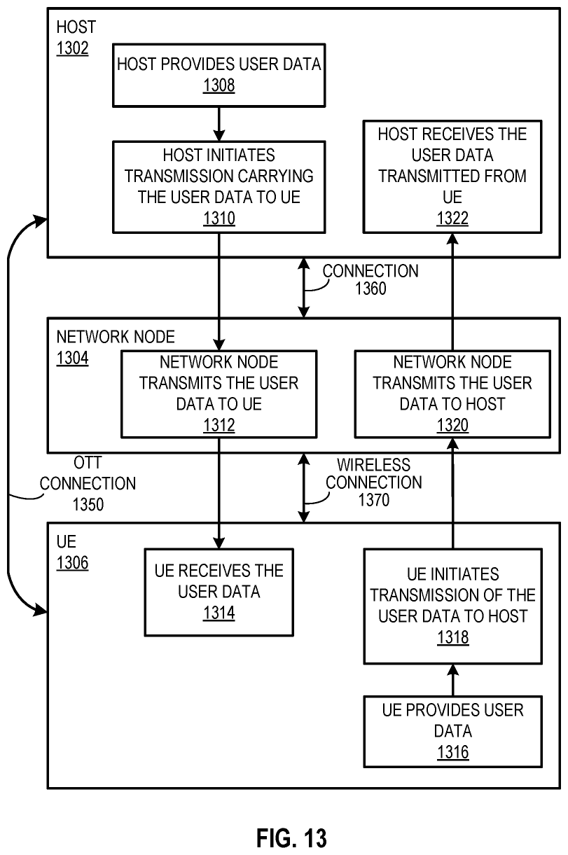

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1.-35. (canceled)

36. A method performed by a network mediation device in a communication network, the method comprising:
receiving application-layer control messages intercepted in the communication network as part of a lawful interception service, wherein each of the application-layer control messages received is configurable to include:
a session identity field indicating an identity of an application-layer control session to which the application-layer control message belongs; and
one or more linking fields that link the identified application-layer control session with another application-layer control session; and
sending, over a handover interface from the network mediation device towards a law enforcement device, the application-layer control messages and signaling indicating which application-layer control messages belong to application-layer control sessions that are linked to one another.

37. A method performed by a law enforcement device, the method comprising:
receiving, over a handover interface from a network mediation device in a communication network, application-layer control messages intercepted in the communication network as part of a lawful interception service, wherein each of the application-layer control messages received is configurable to include:
a session identity field indicating an identity of an application-layer control session to which the application-layer control message belongs; and
one or more linking fields that link the identified application-layer control session with another application-layer control session; and
receiving, over the handover interface, signaling indicating which application-layer control messages belong to application-layer control sessions that are linked to one another.

38. A network mediation device configured for use in a communication network, the network mediation device comprising:
communication circuitry; and
processing circuitry configured to:
receive, at the network mediation device, application-layer control messages intercepted in the communication network as part of a lawful interception service, wherein each of the application-layer control messages received is configurable to include:
a session identity field indicating an identity of an application-layer control session to which the application-layer control message belongs; and
one or more linking fields that link the identified application-layer control session with another application-layer control session; and
send, over a handover interface from the network mediation device towards a law enforcement device, the application-layer control messages and signaling indicating which application-layer control messages belong to application-layer control sessions that are linked to one another.

39. The network mediation device of claim 38, the processing circuitry configured to label each application-layer control message with a field, wherein the signaling comprises the value of the field across the application-layer control messages as labeled, and wherein sending the application-layer control messages and the signaling comprises sending the application-layer control messages as labeled with the field.

40. The network mediation device of claim 39, the processing circuitry configured to set the field to have the same value across application-layer control messages which belong to application-layer control sessions that are linked to one another and to have different values across application-layer control messages which belong to application-layer control sessions that are not linked to one another.

41. The network mediation device of claim 39, wherein the field is an extended session field which is different than a Communications Identity Number field in each application-layer control message.

42. The network mediation device of claim 39, wherein the field is a Communications Identity Number field whose value identifies a communications session.

43. The network mediation device of claim 38, the processing circuitry configured to determine which application-layer control messages belong to application-layer control sessions that are linked to one another, based on the session identity field and the one or more linking fields of each application-layer control message.

44. The network mediation device of claim 38, wherein the application-layer control messages are Session Initiation Protocol (SIP) messages.

45. The network mediation device of claim 44, wherein an application-layer control session corresponds to a SIP call leg, wherein the session identity field is a Call-ID field, and the one or more linking fields include an In-Reply-To field.

46. The network mediation device of claim 38, wherein, for an application-layer control message that is a response to a previous application-layer control message, the one or more linking fields included in the application-layer control message indicate an identity of an application-layer control session to which the previous application-layer control message belongs.

47. The network mediation device of claim 38, wherein the application-layer control messages are messages of an asynchronous communication service.

48. The network mediation device of claim 38, wherein the application-layer control messages are messages of a Short Messaging Service (SMS).

49. A law enforcement device comprising:
communication circuitry; and
processing circuitry configured to:
receive, over a handover interface from a network mediation device in a communication network, application-layer control messages intercepted in the communication network as part of a lawful interception service, wherein each of the application-layer control messages received is configurable to include:
a session identity field indicating an identity of an application-layer control session to which the application-layer control message belongs; and
one or more linking fields that link the identified application-layer control session with another application-layer control session; and
receive, over the handover interface, signaling indicating which application-layer control messages belong to application-layer control sessions that are linked to one another.

50. The law enforcement device of claim 49, wherein each application-layer control message is labeled with a field, wherein the signaling comprises the value of the field across the application-layer control messages as labeled, and wherein receiving the application-layer control messages and the signaling comprises receiving the application-layer control messages as labeled with the field.

51. The law enforcement device of claim 49, wherein the application-layer control messages are Session Initiation Protocol (SIP) messages.

52. The law enforcement device of claim 49, wherein, for an application-layer control message that is a response to a previous application-layer control message, the one or more linking fields included in the application-layer control message indicate an identity of an application-layer control session to which the previous application-layer control message belongs.

53. The law enforcement device of claim 49, wherein the application-layer control messages are messages of an asynchronous communication service.

54. The law enforcement device of claim 49, wherein the application-layer control messages are messages of a Short Messaging Service (SMS).

55. The law enforcement device of claim 49, the processing circuitry configured to process the received application-layer control messages based on which application-layer control messages belong to application-layer control sessions that are linked to one another according to the signaling.
